(19) United States
(12) Patent Application Publication
(10) Pub. No.: US 2008/0063869 A1
(43) Pub. Date: Mar. 13, 2008

(54) Compounding molding system, amongst other things

(75) Inventor: Alireza Mortazavi, Richmond Hill (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/508,574

(22) Filed: Aug. 23, 2006

(51) Int. Cl. B32B 27/18; B29C 45/00

(52) U.S. Cl. 428/411.1; 264/328.17; 425/130; 425/447; 425/135

(57) ABSTRACT

Disclosed is: (i) a method of a compounding molding system, (ii) a compounding extruder of a compounding molding system, (iii) a compounding molding system, (iv) a controller of a compounding molding system, (v) an article of manufacture of a controller of a compounding molding system, (vi) a network-transmittable signal of a controller of a compounding molding system, (vii) a compounded molded article compounded by a compounding molding system, (viii) a molten molding material compounded by a compounding molding system, (ix) a component of a compounding molding system and (x) a mold of a compounding molding system.

### TECHNICAL FIELD

The present invention generally relates to, but is not limited to, molding systems, and more specifically the present invention relates to, but is not limited to: (i) a method of a compounding molding system, (ii) a compounding extruder of a compounding molding system, (iii) a compounding molding system, (iv) a controller of a compounding molding system, (v) an article of manufacture of a controller of a compounding molding system, (vi) a network-transmittable signal of a controller of a compounding molding system, (vii) a compounded molded article compounded by a compounding molding system, and (viii) a molten molding material compounded by a compounding molding system, (ix) a component of a compounding molding system and (x) a mold of a compounding molding system, amongst other things.

### BACKGROUND

Examples of known molding systems are (amongst others): (i) the HyPET™ Molding System, (ii) the Quadloc™ Molding System, (iii) the Hylectric™ Molding System, and (iv) the HyMet™ Molding System, all manufactured by Husky Injection Molding Systems Limited (Location: Bolton, Ontario, Canada; www.husky.ca).

U.S. Pat. No. 5,156,858 (Inventor: Allan et al; Published: 1992-10-20) discloses an apparatus for controlling a molding of a solid product in a mold cavity from molten material which solidifies in the mold cavity (first and second conduits are coupled to the mold cavity at spaced positions for carrying the molten material). The apparatus includes first and second elements, and a controller for controlling the driving the first and second elements repeatedly during solidification of the molten material in the mold cavity so that the molten material is repeatedly moved through the mold cavity. The first element is disposed in the first conduit and the second element is disposed in the second conduit. The first element is adapted to be driven in a forward direction to displace the molten material from the first conduit into the mold cavity and then into the second conduit, while the second element is adapted to be driven in a reverse direction to permit the flow of molten material out of the mold cavity and into the second conduit simultaneously with the driving the first element in the forward direction. The first and second elements are also adapted to be driven in the reverse and forward directions, respectively.

U.S. Pat. No. 5,202,074 (Inventor: Schrenk et al; Published: 1993-04-13) discloses a method of making a multilayer plastic article by forming a multilayer stream of diverse thermoplastic materials and injection molding the multilayer stream directly into the article. The multilayer stream can be formed by co-extrusion of the materials or by co-extrusion followed by layer multiplication in one or more interfacial surface generators/static mixers. The co-extruded stream, or a multiplied stream from the ISG'S, can also be divided into sub-streams and the sub-streams thereafter recombined prior to being injection molded so that the layers in one such sub-stream are angularly oriented with respect to the layers in another sub-stream.

U.S. Pat. No. 5,275,776 (Inventor: Hara et al; Published: 1994-01-04) discloses a method for producing a molded article of a fiber-reinforced thermoplastic resin, which includes (i) supplying a melt mass of a thermoplastic resin which is reinforced with fibers dispersed therein and having an average fiber length of not shorter than 1 millimeter and not longer than 50 mm as a reinforcing material in an unclosed mold in which a film or sheet made of a thermoplastic resin having adhesiveness to a thermoplastic resin is optionally placed, (ii) closing the mold and (iii) pressurizing and cooling it to obtain a molded article.

U.S. Pat. No. 5,443,378 (Inventor: Jaroschek et al; Published: 1995-08-22) discloses a standard injection molding machine is combined with an auxiliary plasticizing unit having a hot runner manifold that can be alternately connected with or disconnected from the main injection unit of the molding machine to perform sandwich molding. The injection unit retracts from the mold to connect with a hot runner and receive skin material from a non-reciprocating screw extruder directly into the barrel of the injection unit. The injection unit then disconnects from the hot runner and moves back into position for injection into the mold. Simultaneously with this movement, the injection unit plasticizes sufficient core material to complete the stacked arrangement of skin and core material that is necessary for sandwich molding. In an alternate embodiment, the sandwich molding apparatus includes an accumulator with a suitable valve and connections to the other components to supply a final shot of skin material into the mold, as well as provide the pack and hold functions of the injection cycle.

U.S. Pat. No. 5,464,585 (Inventor: Fitzgibbon; Published: 1995-11-07) discloses an improved process for molding articles having a bulk material and an auxiliary material, such as an additive or a catalyst, present in the bulk material as a fixed concentration strip or in a concentration gradient in the direction from the surface to the interior. The process is especially useful for concentrating surface-enhancing auxiliary materials at the surface of an article without wasting the auxiliary material in the interior of the article where it provides minimal value. This process is also applicable to concentrating an interior-enhancing auxiliary material in the interior of the article without degrading surface sensitive properties. The method for manufacturing an as-molded article having a bulk material and an auxiliary material provided therein generally comprises injecting a moldable bulk material composition into a mold with an essentially laminar flow profile such that the earlier injected material will reside at the surface of the mold (i.e., the surface of the manufactured article) and the later injected material will constitute the interior portion of the article, and controlling the injection of the auxiliary material during filling of the mold with the bulk material to direct the auxiliary material to a desired location within the bulk material.

U.S. Pat. No. 5,656,215 (Inventor: Eckardt et al; Published: 1997-08-12) discloses a process for the injection molding of objects having an outer layer of enamel and an inter layer of a plastic material is disclosed. According to the process, liquid enamel is used. This enamel is injected by an enamel-injection apparatus through an enamel-injection die. A plastic melt passes through an injection unit into the cavity. According to the process, the liquid enamel is injected into the flow path of the melt in the region before the cavity, before the melt is injected, so that the melt is encased by enamel before it is distributed in the cavity. Variations are also disclosed. For example, the form can be filled with enamel and the excess enamel drained. Then, the melted plastic material is introduced into the injection molding form. Also, the form can filled and then the capacity of the form increased to accommodate the melted plastic material. In any case, it is possible to use liquid enamels to enamel injection molded parts in the tool or form. Furthermore, the inventive process makes possible a rapid and therefore economical mode of operation.

U.S. Pat. No. 5,882,559 (Inventor: Eckardt et al; Published: 1999-03-16) discloses a process for the injection molding of objects having an outer layer of enamel and an inter layer of a plastic material is disclosed. According to the process, liquid enamel is used. This enamel is injected by an enamel-injection apparatus through an enamel-injection die. A plastic melt passes through an injection unit into the cavity. According to the process, the liquid enamel is injected into the flow path of the melt in the region before the cavity, before the melt is injected, so that the melt is encased by enamel before it is distributed in the cavity. Variations are also disclosed. For example, the form can be filled with enamel and the excess enamel drained. Then, the melted plastic material is introduced into the injection molding form. Also, the form can filled and then the capacity of the form increased to accommodate the melted plastic material. In any case, it is possible to use liquid enamels to enamel injection molded parts in the tool or form. Furthermore, the inventive process makes possible a rapid and therefore economical mode of operation.

U.S. Pat. No. 6,287,491 (Inventor: Kilim et al; Published: 2001-09-11) discloses a method of molding plastics articles that includes (i) propelling a solid plastics feed material by screw feed means through a melting zone, the screw feed means, (ii) propelling the resultant molten plastics material to shaping means, (iii) shaping the molten plastics material in the shaping means and allowing the material to solidify to retain the shape, and (iv) varying the composition of the plastics material cyclically before or along the length of the screw feed means so that the molten material emerging from the screw feed means varies in composition with time, whereby at least one part of each molded article is of different composition from the remainder of the article.

U.S. Pat. No. 2003/0047825 (Inventor: Visconti et al; Published: 2003-03-13) discloses a method of making a reinforced component by depositing a polymer into an extrusion deposition unit, during the plastication process a reinforcing material is deposited into the extrusion deposition unit. The amount and type of fiber is varied in order to provide a molded component with varying degrees of reinforcement and/or strength. The extrudate having a varying fiber reinforcement is deposited onto a mold core or cavity.

United States Patent Application Number 2003/0102599 (Inventor: Du Toit; Published: 2003-06-05) discloses a method of molding and a molding installation. The installation includes a compounder, a flow path from the compounder to a vessel in which the moldable material emerging from the compounder is accumulated and further flow paths from the vessel to a number of molders each of which is associated with a mold. The molders take charges of moldable material on a cyclical basis.

U.S. Pat. No. 6,627,134 (Inventor: Thomson; Published: 2003-09-30) discloses an apparatus for injection molding two compatible polymeric materials, in which two substantially coaxial extrusion screws are used to plasticize the two materials into a common accumulation space. The charge comprising multiple layers of material is then injected into a closed mold by means of forward axial motion of the outer screw with respect to its enclosing barrel. Once inside the mold, the first material forms a skin layer totally or partially surrounding the other material. In this way a part having a plurality of material properties may be produced in a single operation.

United States Patent Application Number 2004/0012121 (Inventor: Lang et al; Published: 2004-01-22) discloses a process for making a fiber reinforced molded article is disclosed. The process entails (i) melting a thermoplastic resin (ii) introducing and homogeneously distributing at least one fiber strands to the molten resin to form a mixture of fibers and molten resin and (iii) molding the article by injection or by compression molding, and (iv) solidifying the article. The process is characterized in that where the fiber strands have a fiber length of 2 to 25 mm and in that the molded article contains fibers the mean length of which is at least 400 mum. Lastly the process is characterized in that no cooling or solidifying take place between steps (ii) and (iii).

United States Patent Application Number 2005/0156352 (Inventor: Burkle et al; Published: 2005-07-21) discloses a method of making a multi-component plastic article through a multi-stage injection molding process, with at least one component made of a multiphase plastic mass containing plastic material and an additive. The method includes: (i) compounding plastic material in an extruder with an additive for making a multiphase plastic mass, and (ii) injecting the plastic mass via an injection unit into a mold.

U.S. Pat. No. 7,004,739 (Inventor: Thomson; Published: 2006-02-28) discloses an apparatus for injection molding two compatible polymeric materials, in which two or more plasticizing zones on a screw are used to simultaneously or sequentially plasticize the two materials into a common accumulation space through separate pathways. The charge comprising multiple layers of material is then injected into a closed mold by means of forward axial motion of the screw with respect to its enclosing barrel. Once inside the mold, the first material forms a skin layer, totally or partially surrounding the other material. In this way a part having a plurality of material properties may be produced in a single operation.

FIG. 1 is a schematic representation of a known molding system 1 (hereafter referred to as the “known system 1”), which is a representation of the ad-mix technology to the best understanding of the inventor of the instant application (as may be represented in U.S. Pat. No. 6,287,491). The known system 1 includes, amongst other things, (i) an extruder 2 having a single screw 4 that is driven by a drive unit 22, (ii) a conduit 12 (such as a machine nozzle 32) that connects the extruder 2 to a mold 14, (iii) a stationary platen 34 that is attached to a stationary mold portion 38 of the mold 14, (iv) a movable platen 36 that is attached to a movable mold portion 40 of the mold 14, and (v) hoppers 18, 20 into which pre-made materials 8, 10 are alternatively fed by respective hoppers 18, 20 (first one material and then the other material) into the extruder 2. The extruder 2 is used to melt one material 10 and then to melt the other material 8 (one after the other in a serial manner) so that one layer of melted material 44 in placed adjacent to another layer of melted material 46 (in the extruder 2) so as to make or manufacture united layers 6 (the united layers 6 are molten). The molding material 92 processed by the extruder 2 includes the united layers 6. After a shot accumulated (the shot is located in a barrel head 3 of the extruder 2), the united layers 6 contained in the shot are pushed into the conduit 12 and then into the mold 14. Once the molding material 92 disposed in the mold 14 is solidified, the mold 14 is separated so that a molded article 90 may be extracted from the mold 14. The molded article 90 includes solidified united layers 48, 50. The known system 1 produces the article 90 such that the solidified layer of material 50 is located on the surface of the article 90 and the solidified layer material 48 is located in the middle of the article 90. The solidified layers 48, 50 correspond to the molten layers 44, 46 of the molding material 92. The layer of material 48 may be a re-grind material (a non-virgin material) while the layer of material 50 may be a virgin material.

Disadvantageously, a limitation of the extruder 2 is that the composition of the molding material 92 is limited to layers of the materials 44, 46 that are present in the hoppers 18, 20. For example, if it is desired to have a shot of molding material that included material A, material B, material C and material D, the extruder 2 would require a dedicated hopper for each respective material A to D. There is a limitation of how many hoppers and materials that may be used (or inventoried). The extruder 2 may require an excess of inventory of materials and a number of hoppers. For example, material 8 includes pellets that are pre-made with 10% glass in polypropylene (to be placed in hopper 18). Material 10 includes 30% glass in polypropylene (to be placed in hopper 20). So the molding material will be limited to alternative layers of 10% and 30% glass in polypropylene. If layers of 15% and 25% and 50% of glass in polypropylene are required to manufacture another type of molded article, then new materials would have to be purchased and three hoppers would be needed (when a change is needed, new material would have to be purchased and likely inventoried and managed, etc). This would appear to be a costly approach to manufacturing molded articles.

### SUMMARY

According to a first aspect of the present invention, there is provided a method of a compounding molding system, including (amongst other things) compounding united layers, each of the united layers that were compounded including, at least in part, differing compositions of a primary material and an auxiliary material.

According to a second aspect of the present invention, there is provided a compounding extruder of a compounding molding system, including (amongst other things) a compounding structure couplable to a conduit connected to a mold, the compounding structure configured to, in use, compound united layers, each of the united layers that were compounded including, at least in part, differing compositions of a primary material and an auxiliary material.

According to a third aspect of the present invention, there is provided a compounding molding system, including (amongst other things) a compounding extruder having a compounding structure couplable to a conduit connected to a mold, the compounding structure configured to, in use, compound united layers, each of the united layers that were compounded including, at least in part, differing compositions of a primary material and an auxiliary material.

According to a fourth aspect of the present invention, there is provided a component of a compounding molding system, including (amongst other things) a conduit operatively connectable between the compounding molding system and a mold, the compounding structure configured to, in use, (i) compound united layers, each of the united layers that were compounded including, at least in part, differing compositions of a primary material and an auxiliary material, and (ii) place the united layers that were compounded in the conduit.

According to a fifth aspect of the present invention, there is provided a mold of a compounding molding system, including (amongst other things) a mold body defining a mold cavity receivable of united layers, each of the united layers being compounded by the compounding molding system, each of the united layers that were compounded including, at least in part, differing compositions of a primary material and an auxiliary material.

According to a sixth aspect of the present invention, there is provided a compounded molded article of a compounding molding system, including (amongst other things) united layers compounded by the compounding molding system, the united layers being solidified, each of the united layers that were compounded including, at least in part, differing compositions of a primary material and an auxiliary material.

According to a seventh aspect of the present invention, there is provided a molten molding material of a compounding molding system, including (amongst other things) united layers compounded by the compounding molding system, the united layers being molten, each of the united layers that were compounded including, at least in part, differing compositions of a primary material and an auxiliary material.

According to an eighth aspect of the present invention, there is provided a controller of a compounding molding system, having (amongst other things) a controller-usable medium embodying instructions being executable by the controller, the controller operatively couplable to the compounding molding system, the instructions including executable instructions for directing the controller to control the compounding molding system to compound united layers, each of the united layers that were compounded including, at least in part, differing compositions of a primary material and an auxiliary material.

According to a ninth aspect of the present invention, there is provided an article of manufacture of a controller of a compounding molding system, having (amongst other things) a controller-usable medium embodying instructions executable by the controller, the controller operatively couplable to the compounding molding system, the instructions, including executable instructions for directing the controller to control the compounding molding system to compound united layers, each of the united layers that were compounded including, at least in part, differing compositions of a primary material and an auxiliary material.

According to a tenth aspect of the present invention, there is provided a network-transmittable signal of a controller of a compounding molding system, having (amongst other thing) a carrier signal modulatable to carry instructions executable by the controller operatively couplable to the molding system that were compounded, the instructions including executable instructions for directing the controller to control the compounding molding system to compound united layers, each of the united layers that were compounded including, at least in part, differing compositions of a primary material and an auxiliary material.

A technical effect, amongst other technical effects, of the aspects of the present invention is improved manufacturing of compounded molded articles and/or improved compounded molded articles.

### BRIEF DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

FIG. 1 is a schematic representation of a known molding system;

FIG. 2 is a schematic representation of a compounding molding system according to a first exemplary embodiment (which is the preferred embodiment);

FIG. 3 is a schematic representation of a compounding molding system according to a second exemplary embodiment;

FIG. 4 is a schematic representation of a compounding molding system according to a third exemplary embodiment;

FIG. 5 is a schematic representation of a compounding molding system according to a fourth exemplary embodiment; and

FIG. 6 is a schematic representation of a (i) controller, (ii) an article of manufacture and (iii) a network-transmittable signal, and (iv) instructions that implement a method usable by the controller, all of which are all usable with any one of the compounding molding systems of FIGS. 2, 3, 4 and 5.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### REFERENCE NUMERALS USED IN THE DRAWINGS

The following is a listing of the elements designated to each reference numerals used in the drawings:

| | |
|---|---|
| compounding molding system 100; | component 101; 201; 301 |
| 200; 300 | |
| compounding extruder 102; 202; 302 | |
| compounding structure 104; 204; 304 | united layers 106; 206; 306 |
| united layers 107; 207; 307 | primary material 108; 208; 308 |
| auxiliary material 110; 210; 310 | conduit 112; 212; 312 |
| mold 114; 214; 314 | shooting pot 116 |
| primary hopper 118; 218; 318 | auxiliary hopper 120; 220; 320 |
| drive unit 122; 222; 323 | source 124; 224; 324 |
| transfer channel 126 | distribution valve 128 |
| plunger 130 | machine nozzle 132; 232; 332 |
| stationary platen 134; 234; 334 | movable platen 136; 236; 336 |
| stationary mold portion 138; 238; 338 | movable mold portion |
| | 140; 240; 340 |
| mold cavity 142; 242; 342 | molten layer 144; 244; 344 |
| molten layer 146; 246; 346 | solidified layer 148; 248; 348 |
| solidified layer 150; 250; 350 | barrel 252; 352 |
| valve 354 | mold body 156; 256; 356 |
| compounded molded article 190; 290; | |
| 390 | |
| molten molding material 192; 292; 392 | hot runner 199; 299, 399 |
| transfer channel 252 | shut off valve 254 |
| gear pump 356 | controller 400 |
| controller-usable medium 404 | instructions 406 |
| article of manufacture 408 | network-transmittable signal 410 |
| carrier signal 412 | |
| interface modules 452, 454, 456, | display 464 |
| 457, 458, 459 | |
| keyboard/mouse 466 | central processing unit 460 |
| bus 462 | operation 480 |
| operation 482 | operation 484 |
| operation 486 | operation 488 |

### DETAILED DESCRIPTION OF THE EXEMPLARY EMBODIMENTS

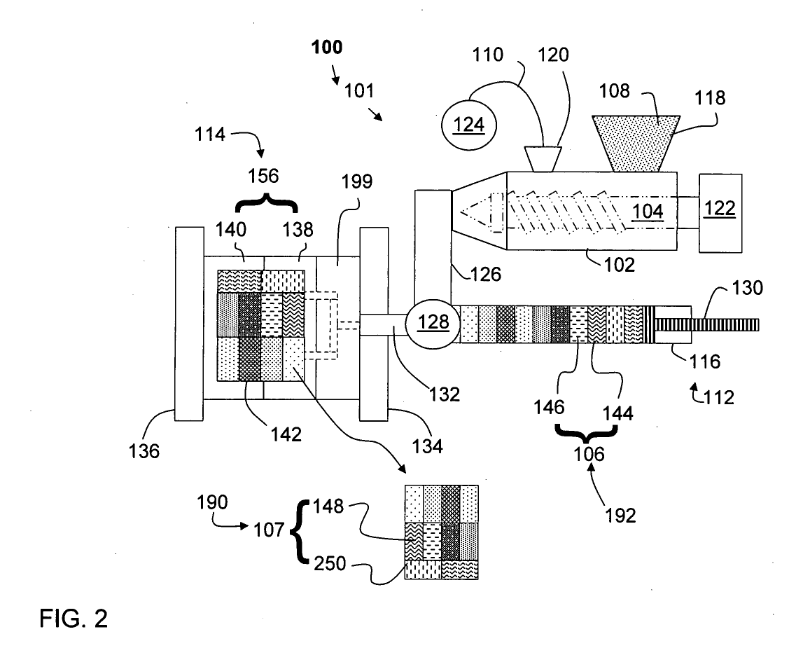

FIG. 2 is a schematic representation of a compounding molding system 100 (hereafter referred to as the “system 100”) according to the first exemplary embodiment. The system 100 includes, amongst other things, a compounding extruder 102 having a compounding structure 104 (such as a screw) that is couplable to a conduit 112 that is, in turn, connected to a mold 114. An example of the conduit 112 is a shooting pot 116. The compounding structure 104 is configured to, in use, compound united layers 106. The united layers 106 are placed adjacent to each other in an abutting relationship (one layer after another layer) so as to form a lamination of layers. Each of the united layers 106 that were compounded includes, at least in part, differing compositions of (i) a primary material 108 (such as a molding material by itself or included with other materials, etc), and (ii) an auxiliary material 110 (such as an additive and/or another molding material, etc). In effect, each layer of the united layers 106 is customized as a result of the compounding efforts of the extruder 102. The auxiliary material 110 may include, for example: (i) a reinforcement, (ii) a filler, (iii) other ingredients (colorant, heat stabilizers, impurities, ultraviolet stabilizers, etc). It is understood that the system 100 may be operated in any mode of molding operation, such as (but not limited to): (i) compression molding, and/or (ii) injection molding.

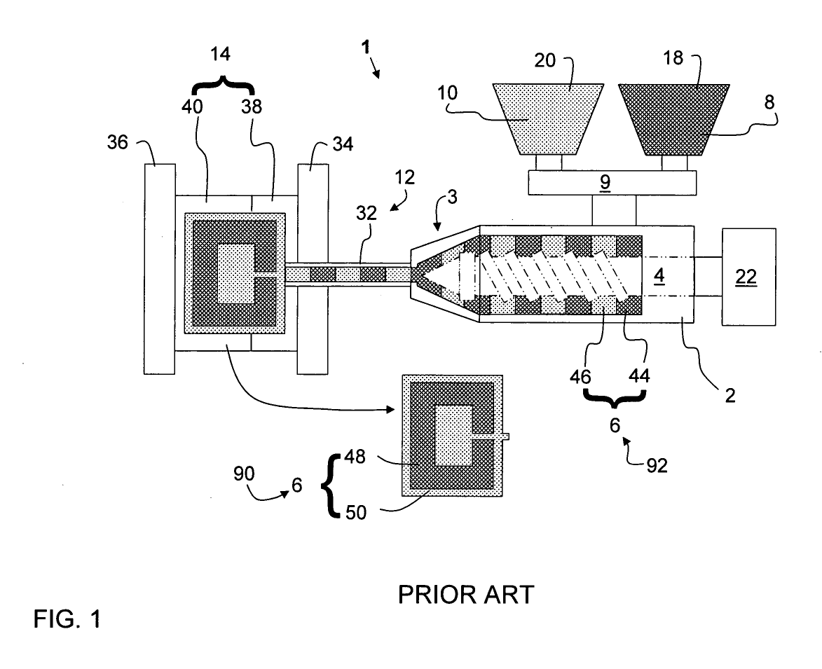

The system 100 compounds (that is, blends and/or mixes) the materials 108, 110 to generate different layers of the united layers 106, so that each layer, preferably, has a specific composition of ingredients or materials at different ratios. It would be within the scope of this embodiment if one layer of the united layers 106 had the same or substantially similar composition as another layer of the united layers 106 (if it was so required). The extruder 102 (i) inputs the primary material 108 and the auxiliary material 110 (via a primary hopper 118 and a auxiliary hopper 120, respectively), and then (ii) compounds the united layers 106; this is in sharp contrast to the known system 1 of FIG. 1 in which the extruder 1 was used to (i) melt the materials 8, 10 (that is, the known system 1 does not compound the materials 8, 10), and then (ii) layer the materials 8, 10. The system 100 injects, in use, a molten molding material 192 that includes the united layers 106 (the united layers 106 are molten) into a mold cavity 142 that is defined by a mold body 156 of the mold 114 (the mold cavity 142 receives the united layers 106). As a result, once the molten united layers 106 are solidified, a compounded molded article 190 is manufactured (solidified) and then removed from the mold 114. The molded article 190 includes united layers 107 (the united layers 107 are solidified). The each layer of the united layers 107 corresponds to a layer of the united layers 106. The united layers 107 are not necessarily layered through thickness but may be layered by spatial variations throughout the article 190. The molded article 190 may (i) a completed article that requires no further processing, and/or (ii) a preform that requires further processing (such as a bottle preform that requires to be blown into a final shape for example). The primary material 108 (or materials) includes, for example, (i) pellets, or (ii) resin such as polypropylene. The auxiliary material 110 (or materials) includes, for example, (i) one or more glass rovings, (ii) an additive, (iii) chopped glass, (iv) fillers (talc, etc), (v) colorant, and/or (vi) calcium carbonate, etc. If the auxiliary material 110 includes a glass roving, a source 124 (such as a roller) may be used (not necessarily required) to keep the glass roving positioned for delivery to the hopper 120.

The components 101 (or parts, such as the compounding extruder 102 and the conduit 112) of the system 100 may be sold separately from the system 100. The components 101 of the system 100 includes, amongst other things, (i) a hot runner 199, (ii) a machine nozzle 132 (which is an example of the conduit 112), (iii) a transfer channel 126 (which is another example of the conduit 112), (iv) a distribution valve 128, and/or (v) a shooting pot 116 (which is yet another example of the conduit 112), all of which may be sold separately from the system 100 and/or may be included in the system 100. The hot runner 199 (may be used if required) is mounted to a stationary platen 134 and a stationary mold portion 138. The mold 114 is then mounted to the hot runner 199 instead of being mounted to the stationary platen 134. Alternatively, if required, the hot runner may be mounted to the movable platen 136 and the movable mold portion 140 while the stationary mold portion 138 is mounted to the stationary platen 134.

Once the united layers 106 are compounded and then placed in a layered form (one layer after another layer), the system 100 pushes or transfers the united layers 106 (via the transfer channel 126 and then through the distribution valve 128) to the shooting pot 116. The transfer channel 126, the distribution valve 128 and the shooting pot 116 are examples of the conduit 112.

Control of the compounding operation of the extruder 102 may be achieved by at least three approaches (control is not limited to these specific approaches). A first-compounding approach includes changing (or modulating) rotational speed of the compounding structure 104 (hereafter, referred to as the “screw 104” for sake of convenient referral) of the extruder 102. A second-compounding approach includes changing or modulating a feed rate of the materials 108, 110 through the hoppers 118, 120, and the feed rate is, preferably, governed by gravimetrical feeders (not depicted, but known to those skilled in the art) so that different ratios of materials 108, 110 may be inputted into the extruder 102. A third-compounding approach includes a combination of the first- and the second-compounding approach. The extruder 102, in use (amongst other things): (i) compounds the materials 108, 110, (ii) layers the compounded materials (one layer after another layer in a united fashion or serial manner) to form the united layers 106, (iii) transfers the united layers 106 (either one layer at a time or several layers at a time) into the shooting pot 116. The technical effect of this arrangement is, from amongst other technical effects: if it was desired to process (for example) polypropylene and glass fiber (as the materials 108, 110), a high number of layers may be compounded, in which each layer has differing ratios of glass fiber to polypropylene that may range, for example, from about 0 to about 70% ratio of glass to polypropylene (70% is considered to be an upper limit for pragmatic purposes but a higher ratio may also be achieved if so desired). By using hoppers 118, 120 and materials 108, 110, it may be possible to manufacture or produce the united layers 106, in which each layer of the united layers 106 has (potentially) a plurality of different ratios of the materials 108, 110 that are compounded on the fly (or in situ) by the extruder 102. By using this approach, it may be possible to reduce inventory of a large variety of prepared (pre-made) materials in sharp contrast to the arrangement depicted in FIG. 1 (known system 1 requires many hoppers and many types of materials to be inventoried). For example, a first layer positioned closest to a piston or a plunger 130 of the shooting pot 116 is 60% glass to polypropylene, a second layer positioned adjacent to the first layer is 40% glass to polypropylene, and a third layer positioned adjacent to the second layer is 55% glass to polypropylene (and so on for each subsequent layer of the united layers 106). It will be appreciated that polypropylene and glass fibers are used as an example, and fillers and/or additives, colorants, etc may be used instead of glass or with the glass.

The shooting pot 116 is used to inject or push the united layers 106 into the mold 114 so that the mold article 190 may be formed. The molded article 190 includes a variation of solidified united layers 107 (each layer of the united layers 107 being a ratio of materials or ingredients). The technical effect of this arrangement is, for example, improved manufacturing of automotive parts. An automotive part will likely be exposed to different stresses or different loads. If higher loads or higher stresses are experienced by certain areas of the molded article 190, it is desirable to have a higher content of glass in those higher-stress areas so that the molded article 190 is as strong as possible in those higher-stress areas so that the molded article 190 may be better able to withstand the extra stresses. For areas of the molded article 190 that will experience lower stresses and lower stressor forces, it is desirable to have a lower amount of glass reinforcement placed in those lower-stress areas in order to optimize design of the molded article 190 so that the molded article 190 is made somewhat more economical, lighter and/or achieve desired design criteria or optimization. The exemplary embodiments allow flexibility in manufacturing the molded article 190 that is not likely achieved with the known system 1 of FIG. 1. Variation of local material composition may be optimized for other purposes, such as (but not limited to): (i) shrinkage of the molded article 190 during molding operation, (ii) coefficient of thermal expansion of the molded article 190, (iii) density of the molded article 190, and/or (iv) color variation of the molded article 190.

Different methods or approaches are used for determining which layers 144, 146 of the united layers 106 will arrive or be placed at which specific parts or areas within the mold cavity 142 of the mold 114. A first-layer placement approach (also known as fill analysis) includes using a best engineering estimate (which will be a close placement but will not likely be an exact placement of each layer of the united layers 106 in the mold cavity 142) that includes modeling flow of the molding material 192 in the mold cavity 142; this approach would likely also include trial and error testing. A second-layer placement approach (also called sequential valve gating) for achieving a desired distribution of the layers of the united layers 106 in the mold 114 includes using sequential valve gating, which is associated with using the hot runner 199, where valve gates are opened and closed at different locations (or time of cycle of the system 100) that lead into the mold cavity 142 in order to direct the layers of the united layers 106 into different locations of the mold 114. A third-placement approach includes combining the above two approaches (sequential valve gating with fill analysis). To use sequential valve gating, the hot runner 199 is used to position the layers in to the mold 114. However, with the first-layer placement approach, it would not be necessary have to use the hot runner 199 (but there would be less control which may not represent an issue for some applications). So if precise control was required, the hot runner 199 may be used so that improved placement of the layers of the united layers 106 may be achieved in the mold 114.

Preferably, the system 100 further includes, amongst other things, tangible subsystems, components, sub-assemblies, etc, that are known to persons skilled in the art. These items are not depicted and not described in detail since they are known. These other things may include (for example): (i) tie bars (not depicted) that operatively couple the platens 134, 136 together, and/or (ii) a clamping mechanism (not depicted) coupled to the tie bars and used to generate a clamping force that is transmitted to the platens 134, 136 via the tie bars (so that the mold 114 may be forced to remain together while a molding material is being injected in to the mold 114). These other things may include: (iii) a mold break force actuator (not depicted) coupled to the tie bars and used to generate a mold break force that is transmitted to the platens 134, 136 via the tie bars (so as top break apart the mold 114 once the molded article 190 has been molded in the mold 114), and/or (iv) a platen stroking actuator (not depicted) coupled to the movable platen 136 and is used to move the movable platen 136 away from the stationary platen 134 so that the molded article 190 may be removed from the mold 114, and (vi) hydraulic and/or electrical control equipment, etc.

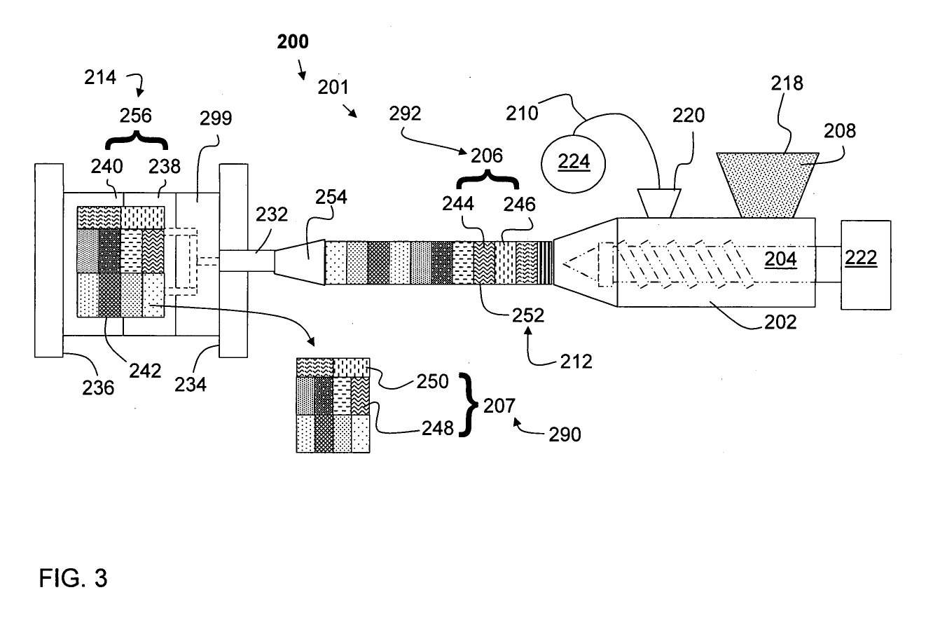

FIG. 3 is a schematic representation of a compounding molding system 200 (hereafter referred to as the “system 200”) according to the second exemplary embodiment. To facilitate an understanding of the second exemplary embodiment, elements of the second exemplary embodiment (that are similar to those of the first exemplary embodiment) are identified by reference numerals that use a two-hundred designation rather than a one-hundred designation (as used in the first exemplary embodiment). For example, the compounding extruder of the second exemplary embodiment is labeled 202 rather than being labeled 102. According to the second exemplary embodiment, a shooting pot is not used while a transfer channel 252 (also called a barrel, etc) and a shut off valve 254 are used. A reciprocating screw 204 is used (to enable pushing of the united layers 206 into a mold 214). The extruder 202 (i) compounds the united layers 206, (ii) places or buffers the united layers 206 in the transfer channel 252, and (iii) pushes or injects the united layers 206 from the transfer channel 252 into the mold 214. The extruder 202 is used, preferably, to generate the injection pressure (for example, by reciprocating action as known to those skilled in the art) in order to push the united layers 206 into the mold 214. The extruder 202 performs the function of the plunger 103 of the shooting pot 116 of FIG. 2 so as to generate enough pressure in order to push the united layers 206 into the mold 214. Alternatively, instead of reciprocating the screw 204, a device such as a gear pump (not depicted) is used, and the gear pump is placed in the melt path located between the extruder 202 and the machine nozzle 232, and the gear pump is used to push the united layers 206 into the mold 214.

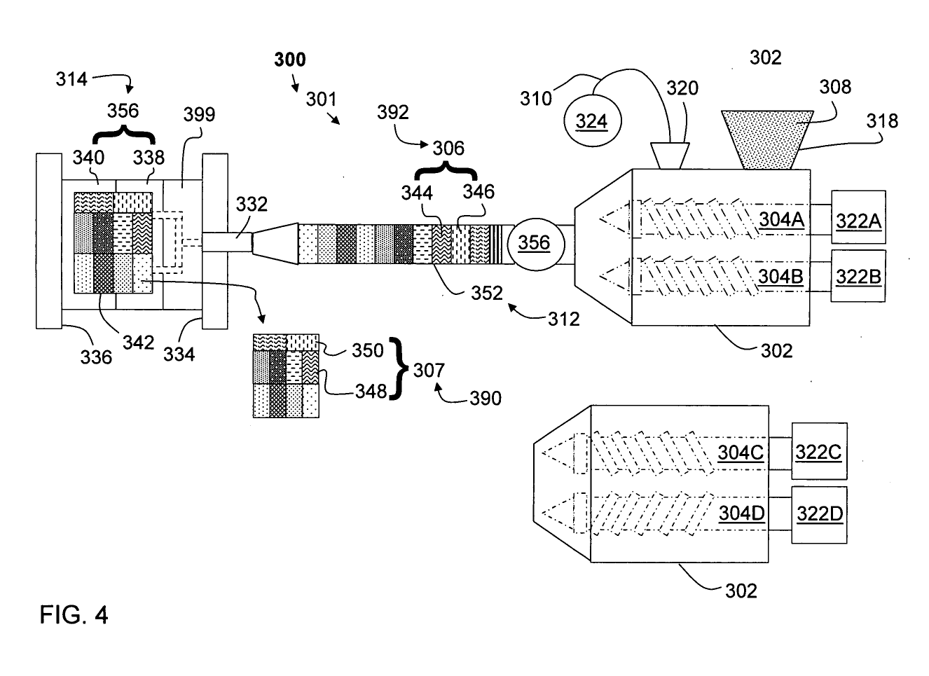

FIG. 4 is a schematic representation of a compounding molding system 300 (hereafter referred to as the “system 300”) according to a third exemplary embodiment. To facilitate an understanding of the third exemplary embodiment, elements of the third exemplary embodiment (that are similar to those of the first exemplary embodiment) are identified by reference numerals that use a three-hundred designation rather than a one-hundred designation (as used in the first exemplary embodiment). For example, the compounding extruder of the third exemplary embodiment is labeled 302 rather than being labeled 102. According to the third exemplary embodiment, the extruder 302 is of the twin screw, co-rotating extruder type. According to a variant, the extruder 302 is of the multiple-screw type. According to another variant, the extruder 302 is of the counter-rotating type. Preferably, the extruder 302 includes two screws 304A, 304B that are driven by respective drive units 322A, 322B. The screws 304A, 304B rotate in the same direction (therefore, the screws 304A, 304B are co-rotating). According to a variant, the extruder 302 includes non-co-rotating screws 304C, 304D that rotate in opposite directions. The embodiments are not limited, in one way or another, to using one or two screws (or multiple screws if required). According to a variant, motion is imparted to the screws 304A, 304B via a single drive unit (not depicted) that is connected to the screws 304A, 304B via a gear box (not depicted). To achieve the pumping action of the extruder 302, there are at least three options or approaches that may be used. According to a first-pumping approach, the extruder 302 does not generate enough pressure on its own, and a device such as a gear pump 356 is used to generate sufficient injection pressure to inject or push the molding material 392 into the mold 314. According to a second-pumping approach, the extruder 302 has sufficient ability to generate enough injection pressure (such as by using the counter-rotating twin screws 304C, 304D to generate enough injection pressure, and therefore the gear pump 356 is not used). According to the third-pumping approach, the extruder 302 uses a single screw (not depicted, but is depicted in FIGS. 2 and 3) that reciprocates and plunges, in which the single screw is used to compound the materials 308, 310 and then by reciprocating the single screw, the single screw would provide the plunging action that is required.

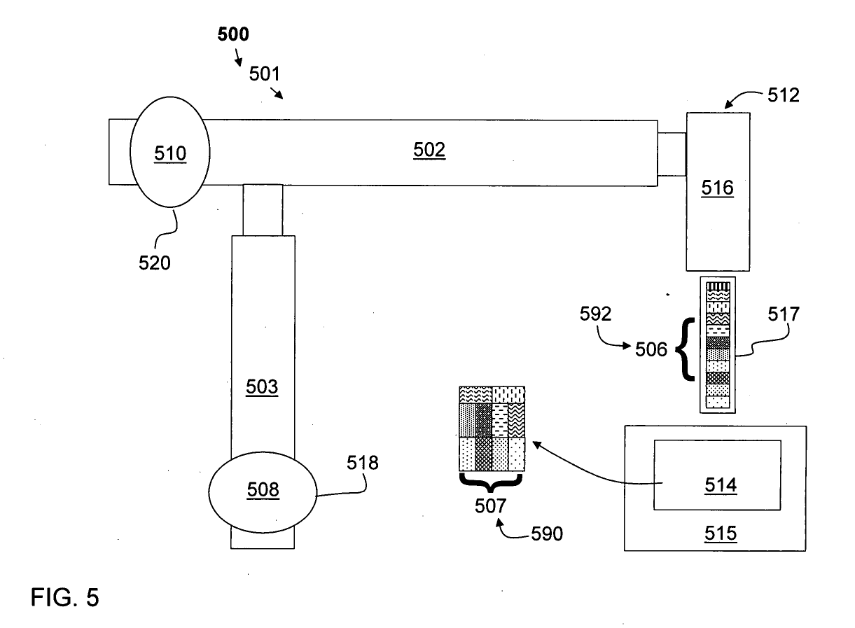

FIG. 5 is a schematic representation of a compounding molding system 500 (hereafter referred to as the “system 500”) according to a fourth exemplary embodiment. To facilitate an understanding of the fourth exemplary embodiment, elements of the fourth exemplary embodiment (that are similar to those of the first exemplary embodiment) are identified by reference numerals that use a five-hundred designation rather than a one-hundred designation (as used in the first exemplary embodiment). For example, the compounding extruder of the fourth exemplary embodiment is labeled 502 rather than being labeled 102. According to the fifth exemplary embodiment, the system 500 operates according to a compression molding process. The system 500 includes, amongst other things, a secondary extruder 502 and a primary extruder 503. A primary hopper 518 receives a primary material 508 and feeds the primary material 508 to the primary extruder 503, which in turn (i) prepares the primary material 508 (that is, melts the primary material 508) and then (ii) feeds the prepared material 508 into the secondary extruder 502. An auxiliary hopper 520 receives an auxiliary material 510 and feeds the material 510 to the secondary extruder 502. The secondary extruder 502 (i) compounds (blends, mixes) the materials 508 and 510 to generate united layers 506 and then (ii) places the united layers 506 into a shooting pot 516 (also called an accumulator). It will be appreciated that the functions of the primary extruder 503 and of the secondary extruder 502 may be combined into a single extruder. The shooting pot 516 pushes the united layers 506 through a die thereby forming a log (that is, a log-shaped extrudate). The log includes any one of: (i) the united layers 506 that extends along a length of the log and/or (ii) the united layers 506 that extends through a cross section of the log. A material-handling mechanism 517 (such as a conveyor or a robot, etc) receives the log from the shooting pot 516 and then in turn the places the log in a mold 514 that is mounted in a vertical press 514. Alternatively, the shooting pot 516 places the log directly into the mold 514). The vertical press 515 is used to close the mold 514 and form a molded article 590; the molded article 590 is then removed from the mold 514 before the next cycle of the system 500 begins.

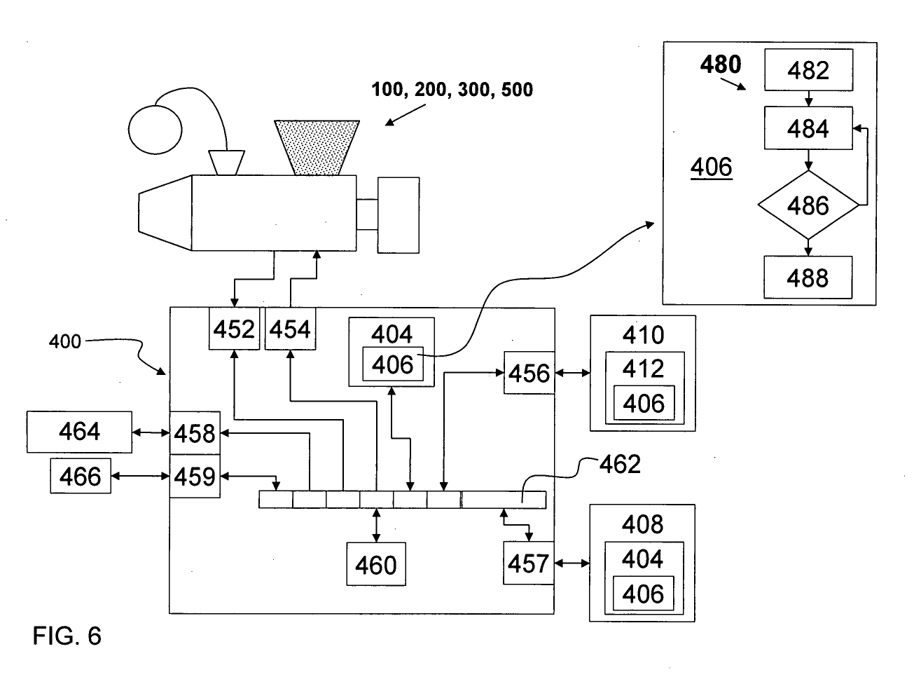

FIG. 6 is a schematic representation of a (i) controller 400, (ii) an article of manufacture 408 and (iii) a network-transmittable signal 410, and (iv) instructions 406 that implement a method usable by the controller 400 according to other exemplary embodiments, all of which are all usable with any one of the compounding molding systems 100, 200, 300, 500 of FIGS. 2, 3, 4 and 5. The systems 100, 200, 300 are operatively couplable to the controller 400 via wireless communications, hardwiring, etc, used for transmitting control-type information and/or data-type information between the systems 100, 200, 300 and the controller 400. The controller 400 is used to control (that is, to direct) the systems 100, 200, 300 according to a method. The method includes, amongst other things, compounding the united layers 106, 206, 306, each of the united layers 106, 206, 306 that were compounded includes differing compositions of the primary material 108, 208, 308 and the auxiliary material 110, 210, 310. The controller 400 is operatively couplable to any one of the systems 100, 200 and/or 300. The controller 400 is programmable and includes a controller-usable medium 404 (such as a hard disk, floppy disk, compact disk, optical disk, flash memory, random-access memory, etc) that embodies programmed instructions 406 (hereafter referred to as the “instructions 406”). The instructions 406 are executable by the controller 400. The instructions 406 include, amongst other things, executable instructions for directing the controller 400 to control the compounding molding system 100, 200, 300 to compound the united layers 106, 206, 306.

The instructions 406 may be delivered to the controller 400 via several approaches: one such approach for delivering the instructions 406 is to use an article of manufacture 408 to deliver the instructions 406 to the controller 400. The article of manufacture 408 includes a controller-usable medium 404 (such as a hard disk, floppy disk, compact disk, optical disk, flash memory, etc) that is enclosed in a housing unit, etc. The controller-usable medium 404 embodies the instructions 406. The article of manufacture 408 is interfacable with the controller 400 (such as via a floppy disk drive reader, etc). Another approach for delivering the instructions 406 is to use a network-transmittable signal 410 (either used separately or in used conjunction with the article of manufacture 408). The network-transmittable signal 410 includes a carrier signal 412 modulatable to carry the instructions 406. The network-transmittable signal 410 is transmitted via a network (not depicted, such as the Internet, etc) and the network is interfacable with the controller 400 by using a modem, etc. The controller 400 includes, amongst other things, interface modules 452, 454, 456, 457, 458, 459 (all known to persons skilled in the art) that are used to interface the controller 400. For example, the interface modules 452, 454 are used to interface the controller 400 to operative sections of the systems 100, 200, 300 such as to thermal sensors, extruder heaters, extruder actuators, etc. The interface module 456 (such as a modem, etc) is used to interface the controller 400 to the network-transmittable signal 410. The interface module 457 (such as a controller-usable medium reader, such as a floppy disk, etc) is used to interface the controller 400 to the article of manufacture 408. Preferably, a display 464 (such as a flat panel display screen, etc) is used as a human-machine interface; the display 464 is interfaced to the controller 400 via an interface module 458. A keyboard and/or mouse 466 (that is, operator control equipment) are interfaced to the controller 400 via an interface module 459. The interface modules 452, 454, 456, 457, 458, 459 are connected to a bus 462 (known to those skilled in the art). The controller 400 also includes a CPU (Central Processing Unit) 460 that is used to execute the instructions 406. The bus 462 is used to interface the interface modules 452 to 457, the CPU 460 and the controller-usable medium 404. The controller-usable medium 404 also includes an operating system (not depicted, but usually maintained in the medium 404) such as the Linux operating system, etc, that is used to coordinate automated processing functions related to maintaining the controller 400 in operational condition. A database (not depicted, but usually maintained in the medium 404) is coupled to the bus 462 so that the CPU 460 may keep data records pertaining to the operational parameters of the systems 100, 200, 300.

The instructions 406 implement a method usable by the controller 400 of FIG. 5. An operation 480 of the instructions 406 are to be executed by the controller 400. The instructions 406 are coded in programmed statements that are written in a controller-programming language, such as (i) a high-level programming language (C++, Java, etc) which is then translated into machine level code or (ii) assembly language/machine code, etc. The instructions 406 are compiled and linked, etc (as known to those skilled in the art) in order to make the instructions 406 executable by the controller 400. Operation 480 includes: (i) operations 482 to 488 inclusive.

Operation 482 includes starting of the instructions 406; control is then transferred to operation 484. Operation 484 includes directing the controller 400 to control the compounding molding system 100, 200, 300 to compound the united layers 106, 206, 306, each of the united layers 106, 206, 306 that were compounded includes differing compositions of the primary material 108, 208, 308 and the auxiliary material 110, 210, 310. Control is then passed to operation 486.

Operation 486 includes directing the controller 400 to determine whether to stop or to temporarily suspend operation 480. If the determination is to stop, control is then transferred to operation 488 (and operation 480 is stopped or is suspended). If the determination is to continue, control is then transferred to operation 484.

Preferably, additional instructions of the instructions 406 include, amongst other things (that is, not limited to): (i) placing the united layers 106, 206, 306 that were compounded in the conduit 112, 212, 312 that is operatively coupled to the mold 114, 214, 314, (ii) pushing the united layers 106, 206, 306 that were compounded from the conduit 112, 212, 312, into the mold 114, 214, 314, (iii) placing the united layers (106; 206; 306) that were compounded in a conduit (112; 212; 312) operatively coupled to a mold (114; 214; 314), (iv) pushing the united layers (106; 206; 306) that were compounded from the conduit (112; 212; 312) into the mold (114; 214; 314), (v) compounding united layers (106; 206; 306) by at least one of (a) modulating rotational speed of a compounding structure (104; 204; 304) of the extruder (102; 202; 302), and (b) modulating a feed rate of the primary material (108; 208; 308) and the auxiliary material (110; 210; 310) to the extruder (102; 202; 302), (vi) placing the united layers (106; 206; 306) within specific portions of the mold cavity 142 of a mold 114, and/or (vii) placing the united layers (106; 206; 306) adjacent to each other in an abutting relationship, one layer after another layer, so as to form a lamination of layers.

According to a variant, the controller 400 controls all aspects of the systems 100, 200, 300 and 500 in accordance with a centralized processing architecture. According to another variant, the controller 400 includes a set of processors or sub-controllers (not depicted) in accordance with a distributed processing architecture, in which the sub-controllers are operatively coupled to selected system components, such as (but not limited to): (i) the hot runners 199, 299 and/or 399, the shooting pots 116 and/or 516, and/or (ii) the extruders 102, 202, 302 and/or 502, etc. In the case of the distributed processing architecture, the sub-controller of the hot runner 199 receives (i) data or information pertaining to layering thicknesses associated with the united layers 106 from the sub-controller of the extruder 102, and (ii) information pertaining to position associated with the plunger of the shooting pot 116, and then the sub-controller of the hot runner 199 uses this information to determine sequential valve gating approach for actuating the valves that are then actuated to fill in the mold 114 with the united layers 106. In the case of the centralized processing architecture, the controller 400 (i) data or information (that is detected by sensors associated with the extruder 102, etc) pertaining to layering thicknesses associated with the united layers 106, and (ii) information (that is detected by sensors associated with the shooting pot 116, etc) pertaining to position associated with the plunger of the shooting pot 116, and then the controller 400 uses this information to determine sequential valve gating approach for actuating the valves that are used to fill in the mold 114 with the united layers 106.

The description of the exemplary embodiments provides examples of the present invention, and these examples do not limit the scope of the present invention. It is understood that the scope of the present invention is limited by the claims. The exemplary embodiments described above may be adapted for specific conditions and/or functions, and may be further extended to a variety of other applications that are within the scope of the present invention. Having thus described the exemplary embodiments, it will be apparent that modifications and enhancements are possible without departing from the concepts as described. It is to be understood that the exemplary embodiments illustrate the aspects of the invention. Reference herein to details of the illustrated embodiments is not intended to limit the scope of the claims. The claims themselves recite those features regarded as essential to the present invention. Preferable embodiments of the present invention are subject of the dependent claims. Therefore, what is to be protected by way of letters patent are limited only by the scope of the following claims:

What is claimed is:

1. A method of a compounding molding system, comprising:
compounding united layers, each of the united layers that were compounded including, at least in part, differing compositions of a primary material and an auxiliary material.

2. The method of claim 1, further comprising:
placing the united layers that were compounded in a conduit operatively coupled to a mold.

3. The method of claim 1, further comprising:
pushing the united layers that were compounded from the conduit into the mold.

4. The method of claim 1, further comprising:
controlling an extruder to compound united layers is achieved by at least one of (i) modulating rotational speed of a compounding structures of the extruder, and (ii) modulating a feed rate of the primary material and the auxiliary material to the extruder.

5. The method of claim 1, further comprising:
placing the united layers within specific portions of a mold cavity of a mold.

6. The method of claim 1, further comprising:
placing the united layers adjacent to each other in an abutting relationship, one layer after another layer, so as to form a lamination of layers.

7. The method of claim 1, wherein at least one layer of the united layers has substantially the same composition as another layer of the united layers.

8. The method of claim 1, further comprising:
extruding a log of the united layers; and
placing the log of the united layers in a mold.

9. A compounding extruder of a compounding molding system, comprising:
a compounding structures couplable to a conduit connected to a mold, the compounding structures configured to, in use, compound united layers, each of the united layers that were compounded including, at least in part, differing compositions of a primary material and an auxiliary material.

10. A compounding molding system, comprising:
a compounding extruder having a compounding structures couplable to a conduit connected to a mold, the compounding structures configured to, in use, compound united layers, each of the united layers that were compounded including, at least in part, differing compositions of a primary material and an auxiliary material.

11. The compounding molding system of claim 10, further comprising:
a shooting pot configured to receive the united layers from the compounding extruder, and (ii) push the united layers onto a conveyor in the form of a log, the log being placable in a mold that is mounted in a vertical press.

12. The compounding molding system of claim 10, wherein the compounding extruder is configured to push the united layers that were compounded from the conduit into the mold.

13. The compounding molding system of claim 10, wherein the compounding extruder is configured to couple to a shooting pot, the shooting pot forming the conduit that receives the united layers that were compounded, the shooting pot configured to, in use, push the united layers that were compounded from the conduit into the mold.

14. The compounding molding system of claim 10, further comprising:
a stationary platen adapted to receivably mount a stationary mold portion of a mold; and
a movable platen adapted to receivably mount movable mold portion of the mold, the stationary mold portion and the movable mold portion defining a mold cavity once the movable mold portion is stroked relative to the stationary mold portion so as to close the mold.

15. The compounding molding system of claim 10, wherein the extruder compounds the united layers by at least one of (i) modulating rotational speed of the compounding structures, and (ii) modulating a feed rate of the primary material and the auxiliary material to the extruder.

16. The compounding molding system of claim 10, wherein the united layers are placed within specific portions of a mold cavity of a mold.

17. The compounding molding system of claim 10, wherein the united layers are placed adjacent to each other in an abutting relationship, one layer after another layer, so as to form a lamination of layers.

18. A component of a compounding molding system, comprising:
a conduit operatively connectable between the compounding molding system and a mold, the compounding structures configured to, in use, (i) compound united layers, each of the united layers that were compounded including, at least in part, differing compositions of a primary material and an auxiliary material, and (ii) place the united layers that were compounded in the conduit.

19. The component of claim 18, wherein the conduit includes at least any one of (i) a hot runner, (ii) a machine nozzle, (iii) a shooting pot, and (v) a transfer channel.

20. A mold of a compounding molding system, comprising:
a mold body defining a mold cavity receivable of united layers, each of the united layers being compounded by the compounding molding system, each of the united layers that were compounded including, at least in part, differing compositions of a primary material and an auxiliary material.

21. A compounded molded article of a compounding molding system, comprising:
united layers compounded by the compounding molding system, the united layer being solidified, each of the united layers that were compounded including, at least in part, differing compositions of a primary material and an auxiliary material.

22. The compounded molded article of claim 21, wherein the primary material includes at least one of a pellet, a resin and polypropylene.

23. The compounded molded article of claim 21, wherein the auxiliary material include at least one of a glass roving, an additive, a chopped glass, a filler, a colorant and calcium carbonate.

24. The compounded molded article of claim 23, wherein the united layers are placed adjacent to each other in an abutting relationship, one layer after another layer, so as to form a lamination of layers.

25. The compounded molded article of claim 23, wherein at least one layer of the united layers has substantially the same composition as another layer of the united layers.

26. A molten molding material of a compounding molding system, comprising:
united layers compounded by the compounding molding system, the united layers being molten, each of the united layers that were compounded including, at least in part, differing compositions of a primary material and an auxiliary material.

27. The molten molding material of claim 26, wherein the primary material includes at least one of a pellet, a resin and polypropylene.

28. The molten molding material of claim 26, wherein the auxiliary material include at least one of a glass roving, an additive, a chopped glass, a filler, a colorant and calcium carbonate.

29. A controller of a compounding molding system, comprising:
a controller-usable medium embodying instructions being executable by the controller, the controller operatively couplable to the compounding molding system, the instructions including executable instructions for directing the controller to control the compounding molding system to compound united layers, each of the united layers that were compounded including, at least in part, differing compositions of a primary material and an auxiliary material.

30. The controller of claim 29, further comprising:
executable instructions for directing the controller to control the compounding molding system to place the united layers that were compounded in a conduit operatively coupled to a mold.

31. The controller of claim 29, further comprising:
executable instructions for directing the controller to control the compounding molding system to push the united layers that were compounded from the conduit into the mold.

32. The controller of claim 29, further comprising:
executable instructions for directing the controller to control the compounding molding system to compound united layers by at least one of (i) modulating rotational speed of a compounding structures of an extruder, and (ii) modulating a feed rate of the primary material and the auxiliary material to the extruder.

33. The controller of claim 29, further comprising:
executable instructions for directing the controller to control the compounding molding system to place the united layers within specific portions of a mold cavity of a mold.

34. The controller of claim 29, further comprising:
executable instructions for directing the controller to control the compounding molding system to place the united layers adjacent to each other in an abutting relationship, one layer after another layer, so as to form a lamination of layers.

35. An article of manufacture of a controller of a compounding molding system, comprising:
a controller-usable medium embodying instructions executable by the controller, the controller operatively couplable to the compounding molding system, the instructions, including executable instructions for directing the controller to control the compounding molding system to compound united layers, each of the united layers that were compounded including, at least in part, differing compositions of a primary material and an auxiliary material.

36. A network-transmittable signal of a controller of a compounding molding system, comprising:
a carrier signal modulatable to carry instructions executable by the controller operatively couplable to the molding system that were compounded, the instructions including executable instructions for directing the controller to control the compounding molding system to compound united layers, each of the united layers that were compounded including, at least in part, differing compositions of a primary material and an auxiliary material.
